(19) United States
(12) Patent Application Publication
(10) Pub. No.: US 2012/0200110 A1
(43) Pub. Date: Aug. 9, 2012

(54) Psychological sun visor cover

(76) Inventor: Jayne Klarr, Tucson, AZ (US)

(21) Appl. No.: 12/931,519

(22) Filed: Feb. 3, 2011

(51) Int. Cl. B60J 3/00

(52) U.S. Cl. 296/97.5; 296/97.6

(57) ABSTRACT

A sun visor cover is comprised of a first material having a first color and an opening, thus forming a pocket which may be placed over a sun visor. While not entirely necessary, it may be advantageous that this first color be one that contrasts well with the color orange. A first alertness field comprising the color orange is placed on or incorporated into the first material, forming a highly contrasting combination. The alertness field could be another piece of fabric, a reflective piece of material, a luminescent piece of material, or an illuminated material such as a light bulb, a light strip, a light emitting diode (LEDs), or a collection of bulbs or LEDs. Additional alertness fields may be placed on the same side of the sun visor cover as the first alertness field and may also be placed on the opposite side of the sun visor cover.

### BACKGROUND OF THE INVENTION

1. Field of the Invention

The present invention relates to a cover for a sun visor in a vehicle such as an automobile or airplane. More specifically, the invention relates to a sun visor cover having a background having a first base color and a foreground having a highly contrasting orange color.

2. Description of the Prior Art

The use of sun visors is well-known in the art. Additionally, sun visor covers have been around for a long time. Some sun visor covers extend the area of the sun visor, thus blocking more light from entering the vehicle. Other sun visor covers are intended to provide reading light for a passenger. However, sun visor covers have not, until now, been adapted to affect the psychological well-being of the vehicle's driver or pilot.

It is well known that driving a vehicle or piloting a plane can become a monotonous task. Many drivers fall asleep and either plow into a vehicle in front of them or drift off the road, often resulting in fatalities or major injuries. Pilots have been known to fall asleep and fly their planes into the sides of mountains or crash into the ground.

Efforts have been taken to reduce the number of sleep related accidents, for drivers at least. Many highways have been outfitted with “rumble strips” on the side of the highway to wake a sleeping driver. Construction zones are often lined with caution devices such as orange signs and cones. Flashing lights on barricades (usually yellow) also alert the driver to possible obstructions or detours in the road.

Many drivers often use alternative means in an attempt to stay awake. Some drink large amounts of coffee or take caffeinated pills or potions. Some roll down the window, hoping a breeze will help keep them awake. Others turn up the radio and sing at the top of their lungs. However, for whatever reason, all of these efforts are not wholly successful in preventing sleep-related accidents. Some method of raising the alertness of the driver or pilot, i.e., improving his psychological condition for driving or flying, must be found.

### SUMMARY OF THE INVENTION

The present invention overcomes the disadvantages and limitations of the prior arts by improving the psychological condition of the driver. The color orange is a powerful motivator to humans and, for this reason, is often used to alert drivers to construction zones. The color orange has been shown to reduce fatigue and motivate people that may not feel like working or staying alert. The color orange has been associated with purposefulness, organization, alertness, joy, happiness, an increased sense of well-being, ambition, and cheerfulness. However, in order to be effective, the color orange must be presented within the visual field of the driver or pilot. Additionally, the psychological effect may be increased if the color orange is placed within a contrasting environment.

The present invention is a sun visor cover that is comprised of a first material, such as fabric, having a first color and an opening, thus forming a pocket which may be placed over a sun visor. While not entirely necessary, it may be advantageous that this first color be one that contrasts well with the color orange. A first alertness field comprising the color orange is placed on or incorporated into the first material, forming a highly contrasting combination. The alertness field could be another piece of fabric, a reflective piece of material, a luminescent piece of material, or an illuminated material such as a light bulb, a light strip, a light emitting diode (LEDs), or a collection of bulbs or LEDs. Additional alertness fields may be placed on the same side of the sun visor cover as the first alertness field and may also be placed on the opposite side of the sun visor cover. In this manner, a driver or pilot may be exposed to the positive psychological effect of the color orange in the day time when the sun visor is deployed to block incoming sunlight and also during the evening when the visor has been rotated away from the windshield.

Various other purposes and advantages of the invention will become clear from its description in the specification that follows and from the novel features particularly pointed out in the appended claims. Therefore, this invention comprises the features hereinafter illustrated in the drawings, fully described in the detailed description of the preferred embodiments, and particularly pointed out in the claims. However, such drawings and description, as well as this Summary of the Invention, disclose just a few of the various ways in which the invention may be practiced and are not limiting on the invention.

### BRIEF DESCRIPTION OF THE DRAWINGS

FIG. 1a is an illustration of the front side of a sun visor cover, according to the invention.

FIG. 1b is an illustration of the back side of a sun visor cover, according to the invention.

### DESCRIPTION OF THE INVENTION

The present invention overcomes the disadvantages and limitations of the prior arts by providing a means of affecting the psychological condition of a driver or pilot by introducing the color orange, preferably in a contrasting environment, to increase alertness while decreasing fatigue.

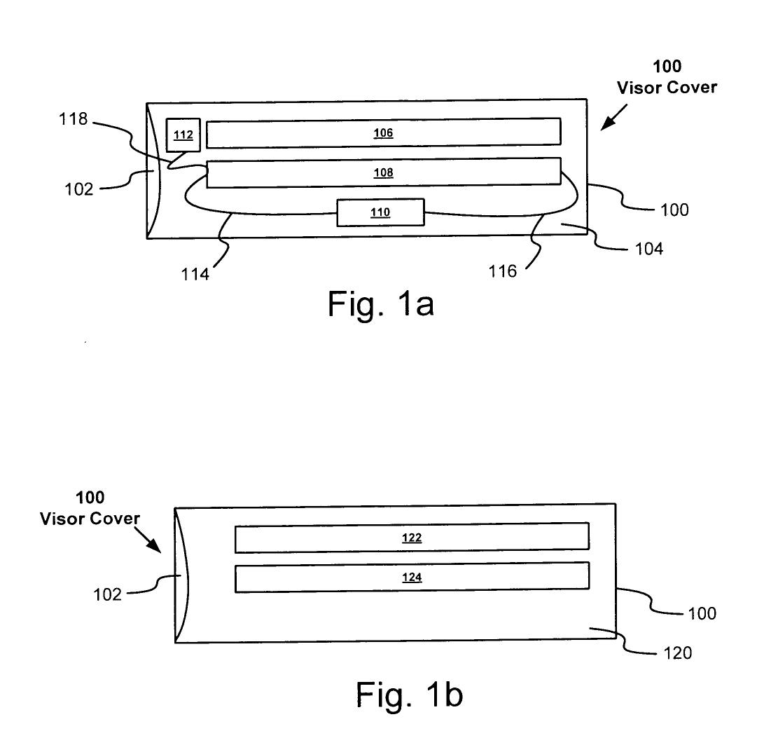

Referring to the figures, wherein like parts are designated with like reference numerals and symbols, FIG. 1 is an illustration of the front side 104 of a visor cover 100. In this embodiment of the invention, the visor cover 100 includes a piece of fabric having a first color. While not absolutely necessary, it is advantageous that this first color contrast well with the color orange. In this embodiment of the invention, the visor cover 100 includes an opening 102, allowing the visor cover to form a pocket which is placed over a sun visor. Alternative means for attaching the visor cover 100 to a sun visor may be applied, such as constructing the visor cover 100 from a substantially square or rectangular piece of fabric, wrapping the visor cover 100 (fabric) around the sun visor and attaching one end of the fabric to another using buttons, snaps, a zipper, or velcro strips (hook and loop fasteners).

In this illustration, the front side 104 is designated as the side of the visor cover 100 that would face the front of the vehicle when the vehicle's sun visor is deployed, thus blocking incoming sunlight. When not deployed, the sun visor may be rotated away from the windshield, usually in and up, so that the front side 104 of the visor cover 100 is facing the top of the head of the driver or pilot. However, other applications of the invention may occur, such as placing the visor cover 100 over a sun visor which rotates in and toward the side. In such an application, the front side 104 of the visor cover 100 would then be facing the side of the head of the driver or pilot.

A first alertness field 106 comprising the color orange is placed on or incorporated into the front side 104 of the visor cover 100, forming a contrasting combination. The first alertness field 106 may be comprised of fabric, a reflective piece of material, a luminescent piece of material, or an illuminating device such as a light bulb, a light strip, a light emitting diode (LED), or a collection of bulbs or LEDs.

In this embodiment of the invention, a second alertness field 108 is placed on or incorporated into the front side 104 of the visor cover 100. As with the first alertness field 106, the second alertness field comprises the color orange. In this illustration, the second alertness field is an illuminating device, as described above, connected to a power source 110 such as a batter by a first wire 114 and a second wire 116. Additionally, an optional switch 112 is provided to activate the illuminating device and is connected by a third wire 118. This switch 112 may be a manual switch operated by the driver or pilot, may be a light sensor that activated the illuminating device is low-ambient light conditions, or a combination of the two.

Different colors of orange provide different psychological effects. The color of the first alertness field 106 may be a cool shade of orange, a warm shade of orange, or a color of orange between the two. Likewise, the color of the second alertness field 108 may be a cool shade of orange, a warm shade of orange, or a color of orange between the two. In this embodiment of the invention, the color of the first alertness field 106 is a warm shade of orange while the color of the second alertness field 108 is a cool shade of orange, providing additional visual contrast to the driver or pilot.

FIG. 1b illustrates an optional embodiment of the invention wherein a third alertness field 122 similar to the first alertness field 106 and/or the second alertness field 108 is placed on the back side 120 of the visor cover 100. Yet another alertness field, the fourth alertness field 124, also similar to the first alertness field 106 and/or the second alertness field 108 and/or the third alertness field 122 may optionally be placed on the back side 120 of the visor cover 100. As with the front side 104 of the visor cover 100, the third alertness field 122 and the fourth alertness field may be comprised of fabric, a reflective piece of material, a luminescent piece of material, or an illuminating device such as a light bulb, a light strip, a light emitting diode (LED), or a collection of bulbs or LEDs. However, because the back side 120 of the visor cover 100 faces the driver or pilot when the visor cover is deployed, implying the presence of strong light such as daylight, in this embodiment of the invention the third alertness field 122 and the fourth alertness field are not illuminated. As with the first alertness field 106 and the second alertness field 108 on the front side 104 of the visor cover 100, the third alertness field 122 and the fourth alertness field 124 may comprise different shades of orange, providing the driver or pilot with an enhanced contrasting environment.

The present invention may be embodied in other specific forms without departing from its spirit or essential characteristics. The described embodiments are to be considered in all respects only as illustrative and not restrictive. All changes which come within the meaning and range of equivalency of the claims are to be embraced within their scope.

I claim:

1. A psychological sun visor cover comprising,
a sleeve comprising an opening forming a pocket adapted to slide over and be secured to a sun visor, the sleeve comprising a front side and a back side, a first alertness field comprising the color orange having a first shade placed onto the front side, a second alertness field comprising an illumination device comprising the color orange having a second shade placed onto the front side, a power source connected to the illumination device by a first wire and a second wire, a switch connected to the illumination device by a third wire, a third alertness field comprising the color orange having a third shade placed onto the back side, and a fourth alertness field comprising the color orange having a fourth shade placed onto the back side.

2. A psychological sun visor cover comprising,
a sleeve comprising an opening forming a pocket adapted to slide over and be secured to a sun visor, the sleeve comprising a front side and a back side, a first alertness field comprising the color orange having a first shade placed onto the front side, and a second alertness field comprising the color orange having a second shade placed onto the front side, a third alertness field comprising the color orange having a third shade placed onto the back side, and a fourth alertness field comprising the color orange having a fourth shade placed onto the back side.

3. A psychological sun visor cover comprising,
a sleeve comprising an opening forming a pocket adapted to slide over and be secured to a sun visor, the sleeve comprising a front side, a first alertness field comprising the color orange having a first shade placed onto the front side, and a second alertness field comprising the color orange having a second shade placed onto the front side.
